(19) United States
(12) Patent Application Publication
(10) Pub. No.: US 2017/0096208 A1
(43) Pub. Date: Apr. 6, 2017

(54) Multi-Layer Fluid Containment Recovery System

(71) Applicant: Jeff Klagenberg, Half Moon Bay, CA (US)

(72) Inventor: Jeff Klagenberg, Half Moon Bay, CA (US)

(21) Appl. No.: 15/285,344

(22) Filed: Oct. 4, 2016

Related U.S. Application Data
(60) Provisional application No. 62/237,857, filed on Oct. 6, 2015.

(51) Int. Cl. B64B 1/62; B64B 1/58; B64B 1/40

(52) U.S. Cl. CPC B64B 1/62; B64B 1/40; B64B 1/58

(57) ABSTRACT

A system and method for multi-layer fluid containment recovery. The system includes an inner container, an outer container and a pump. The outer container encompasses the inner container and forms a region between the inner container and the outer container. The pump includes an inlet situated in the region between the inner container and outer container. The system may also include a logic controller communicatively coupled to the pump and configured to activate the pump in moving fluid out of the region between the inner container and outer container according to a defined logic.

### CROSS REFERENCE TO RELATED APPLICATIONS

This application claims priority under 35 USC §. 119(e) to U.S. Application No. 62/237,857, entitled “Multi-Layer Fluid Containment Recovery System” filed Oct. 6, 2015, the entirety of which is herein incorporated by reference.

### BACKGROUND

The specification relates to recovering fluids in a fluid containment system. In particular, the specification relates to extending flight time of balloons.

One sought after use of high-altitude balloons is in providing Internet connectivity to remote and underdeveloped areas of the world. Several of these high-altitude balloons, miles above the surface of the earth, may form a network of wireless links amongst themselves and provide wireless coverage to a surface area below each balloon. One or more wireless backhaul links may then connect the network to the wider Internet. Other uses of balloons include persistent surveillance (e.g. shipping lanes, pipelines, etc.) and fire detection.

Because balloon systems rely upon buoyancy, an overarching concern for balloon system designers is payload weight. Increased payload weight often requires an ever increasing amount of buoyancy. System designers may adjust buoyancy in the system by varying the volume and density of a gas such as helium contained within the balloon. A system with too heavy of a payload can quickly make a balloon system unwieldy or simply infeasible.

An obstacle to deployment of high-altitude balloons for continuous Internet coverage is the length of flight time for each balloon. Accordingly, significant research and development energy has been exerted to extend flight time of balloons.

### SUMMARY

According to one innovative aspect of the subject matter described in this disclosure, an apparatus includes: a first envelope for containing a buoyant gas with an inner surface facing toward the buoyant gas and an outer surface facing away from the buoyant gas, a second envelope encompassing the first envelope and forming an inter-envelope region between the outer surface of the first envelope and an inner surface of the second envelope facing toward the first envelope, a first pump with an inlet situated in the inter-envelope region and operable to remove gas from the inter-envelope region, and a logic controller communicatively coupled to the first pump to activate the first pump according to defined logic.

According to one innovative aspect of the subject matter described in this disclosure, a method includes: measuring leakage into an inter-vessel region formed between a first vessel and a second vessel that encompasses the first vessel, determining whether the leakage exceeds a first threshold, and activating pump based on the determination of whether the leakage exceeds the first threshold.

According to one innovative aspect of the subject matter described in this disclosure, a system includes: an inner container, an outer container encompassing the inner container and forming region between the inner container and the outer container, and a pump with an inlet situated in the region between the inner container and outer container.

Other aspects include corresponding systems, apparatuses and methods. These and other implementations may each optionally include one or more additional features. For instance, a manifold may be distributed between the outer surface of the first envelope and the inner surface of the second envelope to provide gaseous flow across the inter-envelope region to the first pump. A sensor in the inter-envelope region sensing gaseous pressure in the inter-envelope region may be included. The sensor may be communicatively coupled to the logic controller for activation of the first pump. The sensor may detect at least one of: helium, hydrogen, oxygen, nitrogen, and carbon dioxide, in the inter-envelope region. The sensor may be communicatively coupled to the logic controller for activation of the first pump. The logic controller may activate the first pump to move gas from the inter-envelope region into the first envelope when the sensor detects a threshold level of at least one of: helium and hydrogen in the inter-envelope region. The logic controller may activate the first pump to move gas from the inter-envelope region to outside of the outer surface of the second envelope when the sensor detects a threshold level of at least one of: oxygen, nitrogen and carbon dioxide in the inter-envelope region. A second pump may be situated in part in the inter-envelope region and situated in part outside of the outer surface of the second envelope and operable to move gas from the inter-envelope region to outside the outer surface of the second envelope. The first pump may be situated in part inside of the inner surface of the first envelope and operable to move gas from the inter-envelope region to inside the inner surface of the first envelope. The first pump may include a first outlet situated inside of the inner surface of the first envelope. The first outlet of the first pump may be operable to move gas from the inter-envelope region to inside the inner surface of the first envelope. A second outlet may be situated outside of the outer surface of the second envelope. When the second outlet is operational the second pump may be operable to move gas from the inter-envelope region to outside the outer surface of the second envelope. An outlet valve switchable between at least the first outlet and the second outlet and communicatively coupled to the logic controller may be included. A logger communicatively coupled to the logic controller and operable to receive, store and communicate historical data from one or more sensors, and a communication unit communicatively coupled to the logic controller and operable to transmit data onto a communication network may be included. The logic controller may analyze historical data from logger and effectuate transmission of data through the communication unit based on a deviation from the historical data.

Other additional features may include measuring gaseous pressure in the inter-vessel region. The first threshold may be a measured pressure in the inter-vessel region. Pressure may be measured in the inter-vessel region periodically, it may be determined whether the pressure is below a second threshold, and the pump may be deactivated based on the determination of whether the pressure is below the second threshold. Measuring leakage may include measuring a level of a predefined substance in the inter-vessel region. The pump may be activated to move a fluid from the inter-vessel region into the first vessel. Activating the pump may move a fluid from the inter-vessel region to outside the second vessel. A determination may be made regarding whether majority of the leakage into the inter-vessel region is from fluids escaping the first vessel or from fluids passing into the inter-vessel region from outside the second vessel, and the pump may be configured based on the determination of the majority of the leakage.

Other additional features may include a logic controller communicatively coupled to the pump and configured to activate the pump in moving fluid out of the region between the inner container and the outer container according to a defined logic. A pressure sensor may be included in the region between the inner container and outer container. A power controller communicatively coupled to the logic controller.

Multi-layer fluid containment recovery is advantageous because it may minimize leakage of a fluid out of the containment vessel thereby minimizing or slowing loss of the contained fluid. Moreover, multi-layer fluid containment recovery may minimize leakage of fluids into the containment vessel thereby maintaining a less contaminated fluid in the containment vessel. Significantly, the subject matter may increase high-altitude flight time for balloons. Effusion of fluids (e.g. a gas) thorough a membrane is a function of the fluid pressure and time. In a balloon system a multi-layer fluid containment recover sub-system may utilize an inter-vessel region to capture and pump the lift gas back into the container and slow the net effusion of the lift gas from the balloon system. Thus, the rate of effusion of the lift gas to the outside atmosphere may be lowered as a result of the pumping. Moreover, use of the two envelopes with a low to no pressure inter-envelope region may additionally slow effusion of the lift gas to the outside atmosphere.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a graphic representation illustrating one example of a multi-layer fluid containment recovery system.

FIG. 2 is a block diagram illustrating another example of a multi-layer fluid containment recovery system further detailing sensors, a controller and multiple pumps.

FIG. 3 is a block diagram illustrating another example of a multi-layer fluid containment recovery system with a pump having multiple outlets and an outlet valve.

FIG. 4 is a block diagram illustrating one example of a logic controller.

FIG. 5 is a flow diagram illustrating an example method for recovering fluids in a multi-layer containment system.

FIG. 6 is a flow diagram illustrating another example method for recovering fluids in a multi-layer containment system.

### DETAILED DESCRIPTION

A system and method for recovering fluids is described below. In the following description, for purposes of explanation, numerous specific details are set forth in order to provide a thorough understanding of the specification. It will be apparent, however, to one skilled in the art that the invention can be practiced without these specific details. In other instances, structures and devices are shown in block diagram form in order to avoid obscuring the description. For example, the present instance is described in one instance below primarily with reference to user interfaces and particular hardware. However, the present instance applies to any type of computing device that can receive data and commands, and any peripheral devices providing services.

Reference in the specification to “one example” or “an example” means that a particular feature, structure, or characteristic described in connection with the example is included in at least one instance of the description. The appearances of the phrase “in one example” in various places in the specification are not necessarily all referring to the same example.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present instance of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware instance, an entirely software instance or an instance containing both hardware and software elements. In a preferred instance, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

In storing fluids, it may be desirable to protect against leakage and mitigate the effects of leakage. In many fluid containment systems, leaks may occur due to imperfections in the container or as a result of effusion through the container. For example, because of the atomic size of helium, over-time helium tends to effuse through thin balloon envelopes. In everyday life this is often seen where novelty balloons lose their volume and buoyancy a few days after being inflated.

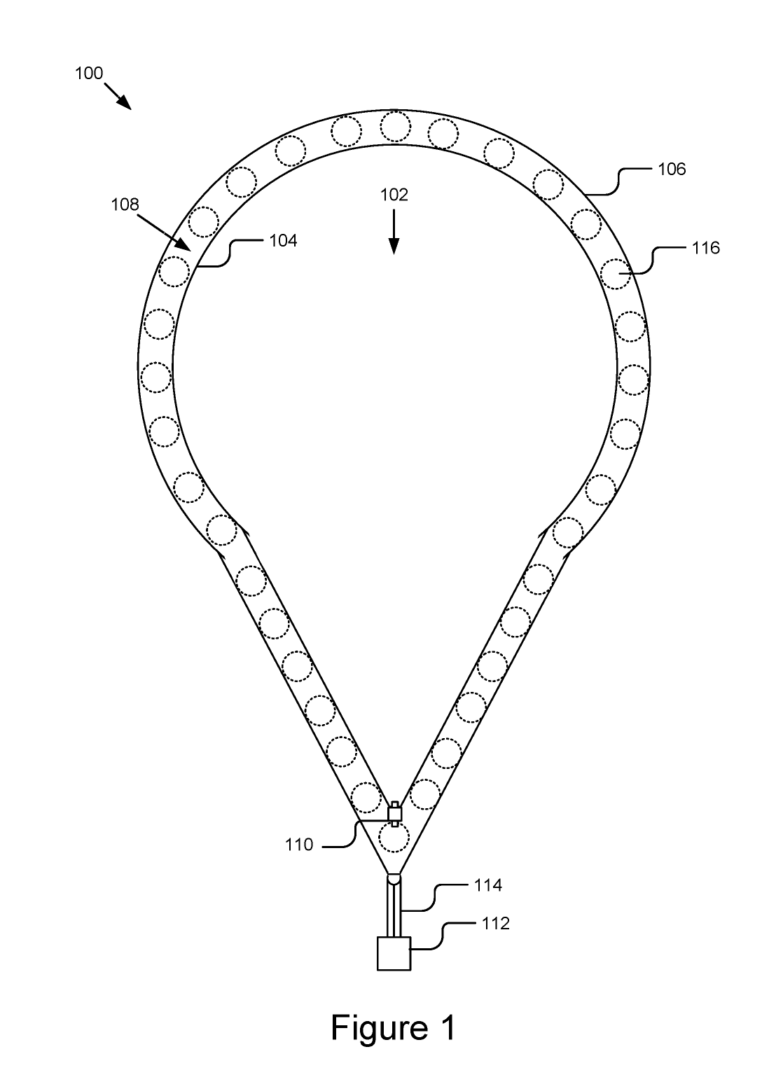

Accordingly, FIG. 1 is a graphic representation illustrating one example of a multi-layer fluid containment recover system. In particular, an exemplary high-altitude balloon system 100 is illustrated with two envelopes. While this example system 100 is generally directed to high-altitude balloons that are launched into the stratosphere, it should be understood that the principles disclosed may also be readily applied to medium-altitude balloons, low-altitude balloons, or other gas containment systems. The first envelope 104 generally contains a buoyant gas 102 such as helium or hydrogen. A second envelope 106 encompasses the first envelope 104 thereby forming an inter-envelope region 108 between the outer surface of the first envelope 104 and the inner surface of the second envelope facing toward the first envelope 104. In some examples, the first envelope 104 may be slightly smaller than the second envelope 106 such that there is some slack between the first envelope 104 and the second envelope 106. In other examples, either the first envelope 104, the second envelope 106, or both the first envelope 104 and the second envelope 106 may include a rigid supporting structure or may be fabricated from a material that is relatively rigid.

In some cases, the first envelope 104 and/or the second envelope 106 may be superpressure balloon envelopes. Superpressure balloons are balloons used at high-altitudes where the volume of the balloon is kept relatively constant in the face of changes in the temperature of the contained lifting gas. As an alternative, the first envelope 104 and/or the second envelope 106 may be variable-volume balloons.

As used herein, the terms “envelope”, “container” and “vessel” are used to refer to a first structure for holding a subject fluid and a second structure encompassing the first structure and forming a region between the two structures. In a buoyant balloon example, the subject fluid may be helium, but other applications may involve a variety of fluids. Throughout this document, the region between the two structures is variously referred to as “inter-envelope region”, “inter-vessel”, “region” and the like.

The high-altitude balloon system 100 also illustrates a pump 110. The pump 110 can move fluids by mechanical action through the expenditure of energy. The pump 110 has an inlet situated in the inter-envelope region 108 and operable to remove gas from the inter-envelope region 108. Specifically illustrated, the pump is arranged to move leaked buoyant gas back into the first envelope 104. The leaked buoyant gas 102 may leak from the first envelope 104 into the inter-envelope region 108 over time due to effusion through and/or imperfection in the first envelope 104. Thus the pump 110 provides a mechanism to return the leaked buoyant gas back into the first envelope 104. In some instances, the pump 110 may be a variable pump.

A manifold 116 may also be included in the high-altitude balloon system 100. In one example, the manifold 116 may be constructed by adhering perforated tubing onto the outer surface of the first envelope 104. While the manifold 116 is depicted as a tubular-based structure placed throughout the inter-envelope region with multiple openings thereon, it should be noted that the manifold may use any mechanism that can keep the first envelope 104 and the second envelope 106 partially separated and thereby allow for more efficient pumping of fluids in the inter-envelope region 108 by allowing less restricted movement of the fluid to the pump. For example, the first envelope 104 or the second envelope 106 may be textured. In another example, open cell foam may be placed in the inter-envelope region 108 as a manifold. Another example includes using plastic tubes as a manifold. Where the gas pressure in the inter-envelope region 108 is low, the first envelope 104 and the second envelope 106 may have a tendency to compress together in various potions of the inter-envelope region 108 and in doing so may prevent free circulation of gas in the inter-envelope region 108 to the pump 110. Thus, the manifold may advantageously allow airflow throughout the inter-envelope region. It should also be noted that in an effort to clearly depict the components of the high-altitude balloon system 100, FIG. 1, as well as the remaining figures, may not necessarily be to scale.

In general the inter-envelope region may have a low to near vacuum pressure such that the inner surface of the second envelope 106 may tend to be largely sucked against the outer surface of the first envelope 104. In an alternate example, the outer surface of the first envelope 104 and/or the inner surface of the second envelope 106 may be textured to provide a similar airflow mechanism without the need for adding an additional manifold 116.

The high-altitude balloon system 100 also includes a payload 112 attached to the second envelope 106 with cords 114. The payload 112 may include antennas and communication devices for networking with other high-altitude balloons and/or providing surface coverage to the area beneath the high-altitude balloon system 100. The payload may also include batteries to store energy, solar panels to collect energy during the day and logic controllers to control various subsystems within the high-altitude balloon system 100.

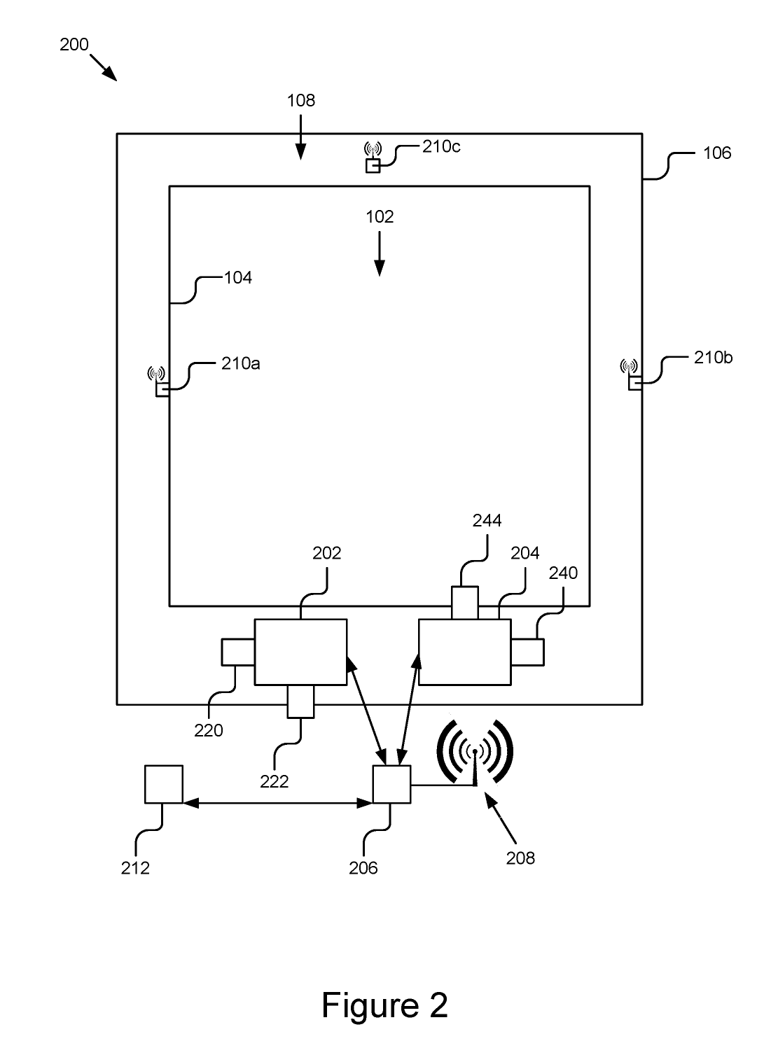

FIG. 2 is a block diagram illustrating another example of a multi-layer fluid containment recovery system 200 detailing sensors 210, a logic controller 206 and multiple pumps 202, 204. In addition to the first envelope 104, the second envelope 106 and the inter-envelope region 108 described above, FIG. 2 includes a sensor 210a located on the left side of the first envelope 104, another sensor 210b located on the inner surface of the second envelope 106 and a third sensor 210c located toward the top of the multi-layer fluid containment recovery system 200. While illustrated as being in wireless communication with the logic controller 206 via the communication unit 208, it should be noted that the sensors 210 may be directly wired to the logic controller 206. In high-altitude balloon implementations, specific communication coupling mechanism may be dependent on added system weight and/or energy usage. In some examples, added energy usage in itself may contribute to added system weight by requiring additional batteries or solar panels to be installed on the system.

Regardless of the particular communication mechanism between the sensors 210 and the logic controller 206, the logic controller 206 may also be communicatively coupled to the first pump to activate the first pump according to defined logic. Further the logic controller 206 may be operable to maintain a low gaseous to near vacuum pressure in the inter-envelope region. To do so, the logic controller 206 may activate one or more pumps 202, 204 when the sensors 210 communicate to the logic controller 206 that there is gaseous pressure in the inter-envelope region 108. Thus in one example, the sensors 210 may sense gaseous pressure in the inter-envelope region 108. In other examples the sensors 210 may detect whether specific types of fluids are present in the inter-envelope region 108. For example, the sensors 210 may detect the presence of helium, hydrogen, oxygen, nitrogen, and/or carbon dioxide in the inter-envelope region 108. After receiving communication from the sensors the logic controller 206 may activate the pump based on the received communication from the sensors 210 (e.g. the presence of helium in the inter-envelope region).

In some instances, one or more of the pumps 202, 204 may be variable pumps. The variable pump may vary the pumping rate based on data continuously supplied by the sensors 210 to the logic controller 206. For example, the variable pump may increase the pumping rate when there is an increase in fluid pressure in the inter-envelope region. Similarly, the variable pump may decrease the pumping rate when there is a decrease in fluid pressure in the inter-envelope region. In some instances, a low fluid pressure threshold may cause the logic controller to shutoff the variable pump. For example, a low fluid pressure threshold may be set to a point where the pumping efficiency of the variable pump drops off

In some instances, the multi-layer fluid containment recovery system 200 includes multiple pumps 202, 204. Part of the first pump 204 may be situated inside of the inner surface of the first envelope 104 and operable to move gas from the inter-envelope region 108 to inside the inner surface of the first envelope 104. In the depicted example, the inlet 240 is situated inside the inter-envelope region 108 and the outlet 244 is situated inside the first envelope 104. Part of the second pump 202 may be situated in the inter-envelope region 108 and part of the second pump 202 may be situated outside of the outer surface of the second envelope 106 and operable to move gas from the inter-envelope region 108 to outside the outer surface of the second envelope 106. In the depicted example, the inlet 220 is situated inside the inter-envelope region 108 and the outlet 222 is situated outside the second envelope 106. Thus the multi-layer fluid containment recovery system 200 may also mitigate effusion or other leakage into the inter-envelope region 108 from outside the second envelope 106.

It should be noted here that while the illustrated examples depict only a first envelope 104 and a second envelope 106, in some applications it may be advantageous to have more than two envelopes. For example, three envelopes may be advantageous where effusion or other leakage into the inner envelope poses a problem. While some of the depicted example are described as handling both leakage direction scenarios, having two separate inter-envelope regions may allow for more discrete pumping directions (i.e. into the inner envelope or to the outside).

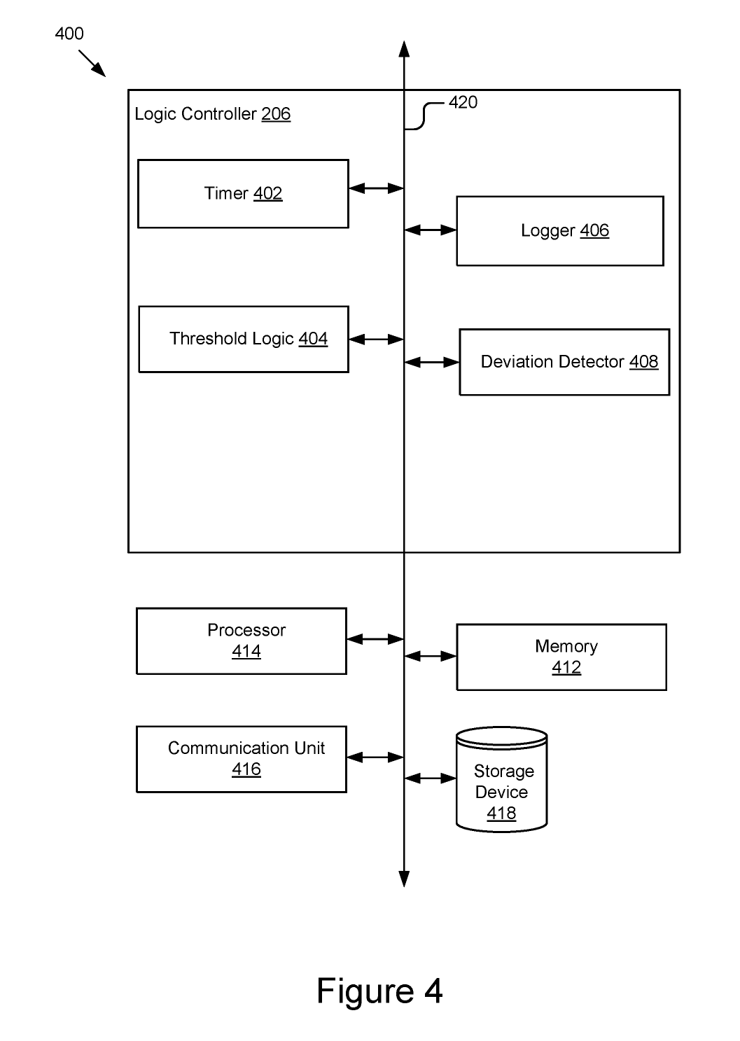

The logic controller 206 is communicatively coupled to the pumps 202, 204. The logic controller 206 activates the one or more pumps according to defined logic and is operable to maintain a low pressure in the region between the inner container and outer container by moving fluid out of the region between the inner container and outer container. The logic controller 206 is discussed in further detail below with reference to FIG. 4. Additionally, a power controller 212 is communicatively coupled to the logic controller 206. The power controller 212 may log information such as power generation, power usage, battery capacity, and battery depletion. With the logged information, the power controller 212 and the logic controller 206 may use machine learning to determine the most effective periods in which to activate the pumps. For example, a particular time of day where solar radiation is prevalent and batteries are fully charged may be a good time to activate pumping. Sensor thresholds for pump activation may be influenced by such an energy scenario.

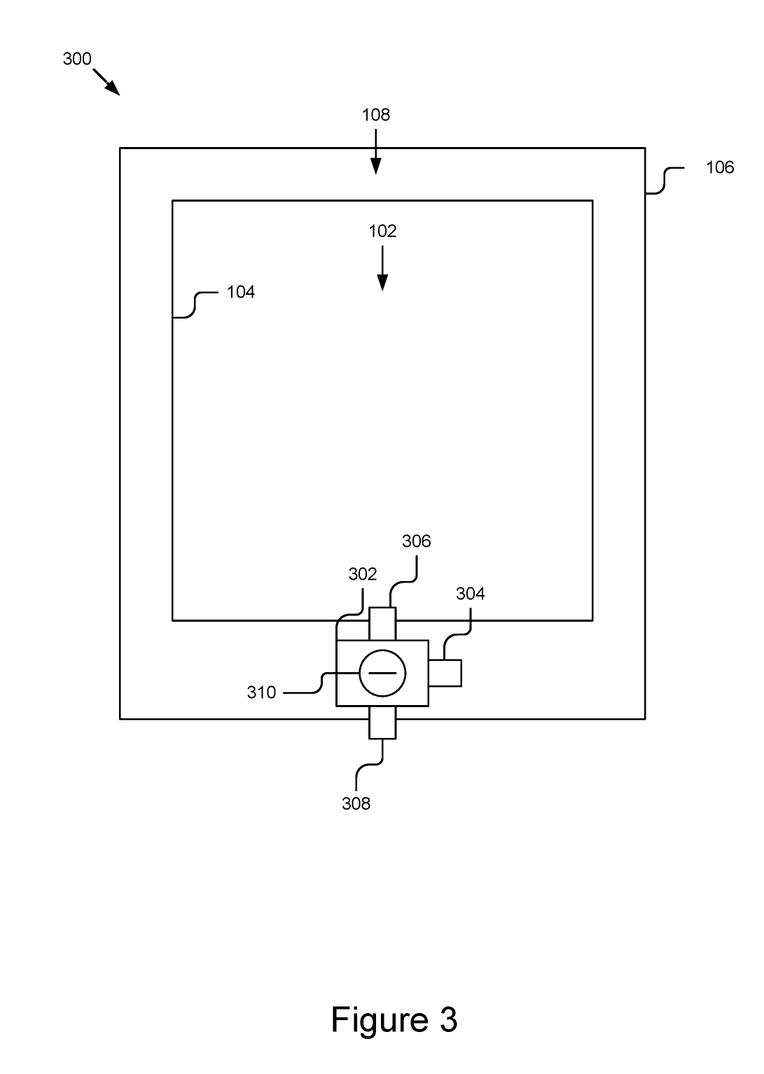

FIG. 3 is a block diagram illustrating another example of a multi-layer fluid containment recovery system 300 with a pump 302 having in inlet 304, multiple outlets 306, 308 and an outlet valve 310. An inlet 304 to the pump 302 is situated within the inter-envelope region 108. A first outlet 306 is situated inside of the inner surface of the first envelope. The first outlet 306 of the pump 302 is operable to move fluids from the inter-envelope region 108 to inside the inner surface of the first envelope 104. A second outlet 308 is situated outside of the outer surface of the second envelope 106. When the second outlet 308 is operational, the pump 302 is operable to move fluids from the inter-envelope region 108 to outside the outer surface of the second envelope 106. An outlet valve 310 is switchable between the first outlet 306 and the second outlet 308. Additionally, the outlet valve 310 may be communicatively coupled to the logic controller such that the logic controller may electrically switch the valve. In one implementation, the outlet valve 310 may include a pneumatic or hydraulic solenoid.

In some implementations the first envelope 104 and/or the second envelope 106 may be rigid or include structural supports providing supplemental rigidity. In some examples, the first envelope 104 and the second envelope 106 may be fabricated from relatively inelastic material.

In some instances, the sensors 210 detect helium and/or hydrogen in the inter-envelope region 108 and activates the pump 302 to move fluids from the inter-envelope region 108 into the first envelope 104 when the sensors 210 detect a threshold level of the helium and/or hydrogen. In particular, the logic controller 206 may receive data from the sensors 210 and activate the outlet valve 310 to open the first outlet 306. The logic controller 206 may then activate the pump 302 such that the pump 302 moves the gas from the inter-envelope region 108 to inside the first envelope 104.

Likewise the sensors 210 may detect oxygen, nitrogen, carbon dioxide, etc. in the inter-envelope region 108 and activate the pump 302 to move fluids from the inter-envelope region 108 outside the second envelope 106 when the sensors 210 detect a threshold level of the oxygen, nitrogen and/or carbon dioxide. In particular, the logic controller 206 may receive data from the sensors 210 and activate the outlet valve 310 to open the second outlet 308. The logic controller 206 may then activate the pump 302 such that the pump 302 moves the gas from the inter-envelope region 108 to outside the second envelope 106.

FIG. 4 is a block diagram illustrating one example of a logic controller 206. FIG. 4 is a block diagram of a computing device 400 that includes the logic controller 206, a memory 412, a processor 414 and a communication unit 416. Optionally, the computing device 400 also includes a storage device 418.

The processor 414 comprises an arithmetic logic unit, a microprocessor, a general purpose controller or some other processor array to perform computations and provide electronic display signals to a display device. Processor 414 processes data signals and may comprise various computing architectures including a complex instruction set computer (CISC) architecture, a reduced instruction set computer (RISC) architecture, or an architecture implementing a combination of instruction sets. Although only a single processor is shown in FIG. 4, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 412 stores instructions and/or data that may be executed by processor 414. The memory 412 is coupled to the bus 420 for communication with the other components. The instructions and/or data may comprise code for performing any and/or all of the techniques described herein. The memory 412 may be a dynamic random access memory (DRAM) device, a static random access memory (SRAM) device, flash memory or some other memory device known in the art. In one instance, the memory 412 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis.

The communication unit 416 receives data from other devices. The communication unit 416 is coupled to the bus 420. In one instance, the communication unit 416 includes a port for direct physical connection to a network or to another communication channel. For example, the communication unit 416 includes a USB, SD, CAT-5 or similar port for wired communication with the network. In another instance, the communication unit 416 includes a wireless transceiver for exchanging data with the network, or with another communication channel, using one or more wireless communication methods, such as IEEE 802.11, IEEE 802.16, BLUETOOTH®, near field communication (NFC) or another suitable wireless communication method. In one instance, the communication unit 416 includes a NFC chip that generates a radio frequency (RF) for short-range communication.

The storage device 418 stores instructions and/or data that may be executed by the processor 414. For example, the storage device 418 stores historical data. The storage device 418 is communicatively coupled to the bus 420 for communication with the other components of the computing device 400.

In the depicted instance, the logic controller 206 includes a timer 402, threshold logic 404, a logger 406 and a deviation detector 408 that are each connected to the bus 420.

The timer 402 provides a periodic mechanism to schedule and execute time-based computing jobs. The threshold logic 404 retrieves thresholds (i.e. upper or lower thresholds) from the storage device 418 and compares them to sensor data received through the communication unit 416. In some cases, thresholds can change over the life of a system the threshold logic 404 updates the thresholds stored in the storage device 418 on a rolling or averaging basis. Thus the threshold logic 404 may communicate with the logger 406 and/or the deviation detector 408 to determine appropriate thresholds for the life and/or condition of the containment system. Additionally, the threshold logic 404 may be communicatively coupled to a battery monitor (not shown) and may receive data indicating the amount of energy available to the system. The threshold logic may base a threshold on the indicated amount of energy available. The logger 406 receives data from the sensors 210 via the communication unit 416 and logs the data by storing the data with the storage device 418. The deviation detector 408, in contrast with the threshold logic 404, detects more radical deviations from historical data retrieved from the logger 406. If a spike occurs in a given fluid, the deviation detector 408 may notify a ground control crew of the deviation by transmitting information through the communication unit 416 onto a network to the ground control crew. Thus, in some example implementations a logger 406 is communicatively coupled to the logic controller 206 and operable to receive, store and communicate historical data from one or more sensors 210. Further, a communication unit 416 is communicatively coupled to the logic controller and operable to transmit data onto a communication network. The logic controller 206 analyzes historical data from logger 406 and effectuates transmission of data through the communication unit 416 based on a deviation from the historical data.

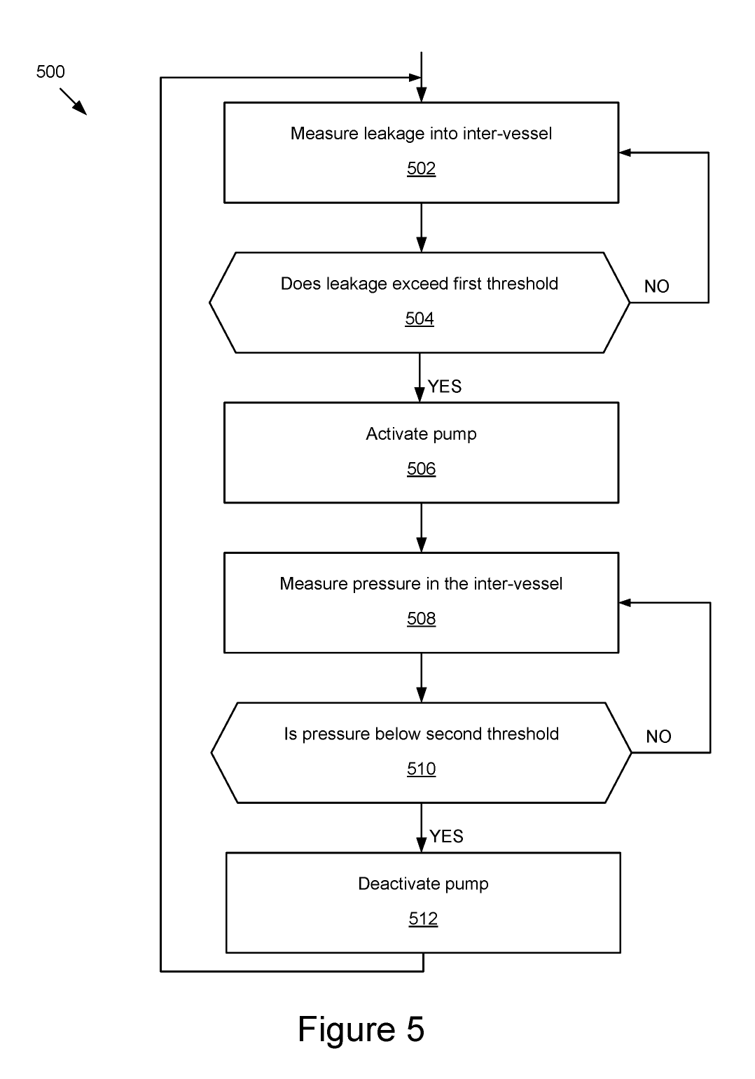

FIG. 5 is a flow diagram illustrating an example method 500 for recovering fluids in a multi-layer containment system. Leakage into an inter-vessel region formed between a first vessel and a second vessel that encompasses the first vessel is measured 502 by one or more sensors 210. In one instance, the leakage into the inter-vessel region is measured 502 by a pressure sensor.

A determination by the logic controller 206 is made to whether the leakage exceeds 504 a first threshold. In particular the threshold logic 404 of the logic controller 206 retrieves the first threshold from the storage device 418 and compares the first threshold to the measured leakage in the inter-vessel region received from the one or more sensors. If the first threshold is exceeded the pump is activated 506.

In one instance, where the leakage into the inter-vessel is measured 502 by a pressure sensor, the pump may be activated 506 if the measured pressure in the inter-vessel region exceeds a limit. Additionally, in some instances, the leakage into the inter-vessel region over time may be logged with logger 406 and the threshold limit may adapt throughout the life of the system. For example, a threshold pressure for activating 506 the pump may be lowered as the overall amount of helium that leaks into the inter-vessel increases per unit time with deterioration of the inner container during an extended flight.

If the first threshold is not exceeded the timer 402 schedules another reading from the sensors 210. In one example, measuring leakage includes measuring gaseous pressure in the inter-vessel region. Thus the first threshold may be a measured pressure in the inter-vessel region. In another example, measuring leakage may include measuring a level of a predefined substance (e.g. helium, hydrogen, ozone, atomic oxygen, molecular oxygen, etc.) in the inter-vessel region.

In the illustrated method 500, the pressure is periodically re-measured 508 until it is determined that the pressure is below 510 a second threshold. Similar to the first threshold, the threshold logic 404 compares data received from the sensors with the second threshold retrieved from the storage device 418. If the pressure is below the second threshold, the logic controller deactivates 512 the pump and cycles back into periodically measuring 502 leakage.

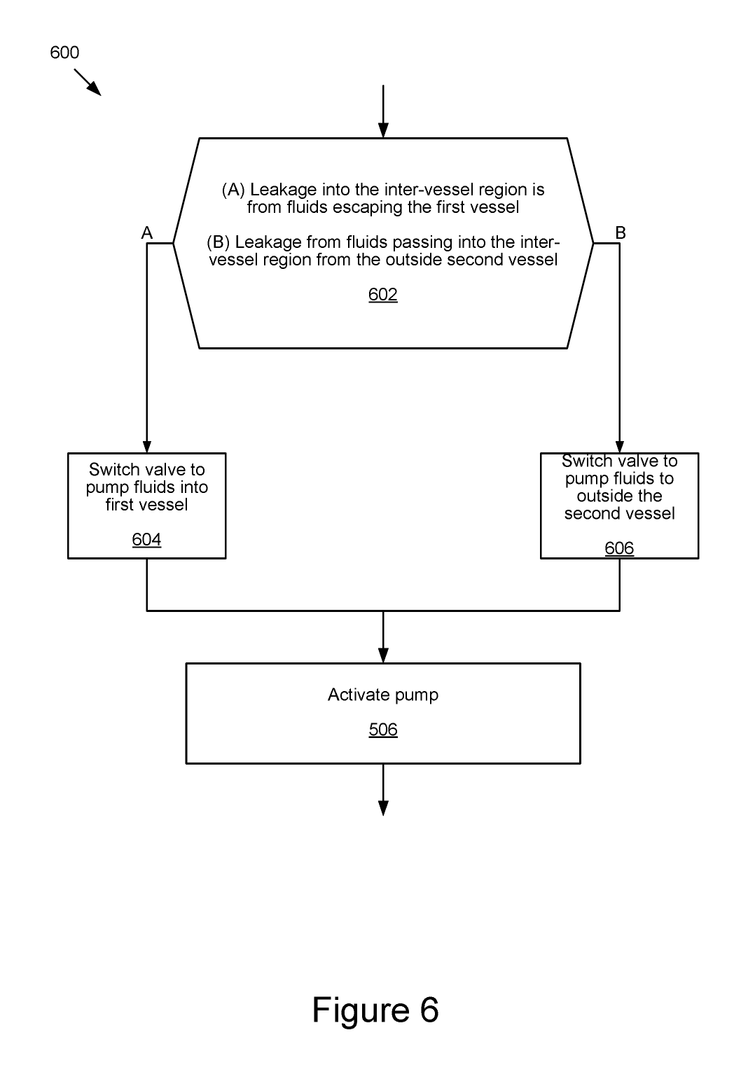

FIG. 6 is a flow diagram illustrating another example method 600 for recovering fluids in a multi-layer containment system. In particular, the method 600 may be used to control an outlet valve 310 based on sensor data communicated to the logic controller 206. The method 600 determines 602 whether a majority of the leakage into the inter-vessel region is from fluids escaping the first vessel or from fluids passing into the inter-vessel region from outside the second vessel. If the leakage into the inter-vessel region 108 is from fluids escaping the first vessel 104, the outlet valve 310 it configured 604 to pump fluids into the first vessel 104. If the leakage into the inter-vessel region 108 is from fluids passing into the inter-vessel region 108 from outside the second vessel 106, the outlet valve 310 it configured 606 to pump fluids to the outside of the second vessel 106. The pump 302 is then activated 506 such that the pump 302 moves fluids from the inter-vessel region 108 into the first vessel 104, or moves fluids from the inter-vessel region 108 to outside the second vessel 106.

While the terms envelope, container, and vessel are used herein with their ordinary meaning, it should also be understood that those terms have also been used interchangeably to facilitate ease in reading this specification.

The foregoing description of the instances of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A high-altitude balloon apparatus comprising:
a first envelope capable of containing a buoyant gas with an inner surface facing toward the buoyant gas and an outer surface facing away from the buoyant gas;
a second envelope encompassing the first envelope and forming an inter-envelope region between the outer surface of the first envelope and an inner surface of the second envelope facing toward the first envelope;
a first pump with an inlet situated in the inter-envelope region and operable to remove gas from the inter-envelope region; and
a logic controller communicatively coupled to the first pump to activate the first pump according to defined logic.

2. The high-altitude balloon apparatus of claim 1, further comprising a manifold distributed between the outer surface of the first envelope and the inner surface of the second envelope to provide gaseous flow across the inter-envelope region to the first pump.

3. The high-altitude balloon apparatus of claim 1, further comprising a sensor in the inter-envelope region sensing gaseous pressure in the inter-envelope region, the sensor being communicatively coupled to the logic controller for activation of the first pump.

4. The high-altitude balloon apparatus of claim 1, further comprising a sensor capable of detecting at least one of: helium, hydrogen, oxygen, nitrogen, and carbon dioxide, in the inter-envelope region, the sensor being communicatively coupled to the logic controller for activation of the first pump.

5. The high-altitude balloon apparatus of claim 4, wherein the logic controller activates the first pump to move gas from the inter-envelope region into the first envelope when the sensor detects a threshold level of at least one of: helium and hydrogen in the inter-envelope region.

6. The high-altitude balloon apparatus of claim 4, wherein the logic controller activates the first pump to move gas from the inter-envelope region to outside of an outer surface of the second envelope when the sensor detects a threshold level of at least one of: oxygen, nitrogen and carbon dioxide in the inter-envelope region.

7. The high-altitude balloon apparatus of claim 1, further comprising:
a second pump situated in part in the inter-envelope region and situated in part outside of an outer surface of the second envelope and operable to move gas from the inter-envelope region to outside the outer surface of the second envelope, wherein the first pump is situated in part inside of the inner surface of the first envelope and operable to move gas from the inter-envelope region to inside the inner surface of the first envelope.

8. The high-altitude balloon apparatus of claim 1, wherein the first pump comprises:
a first outlet situated inside of the inner surface of the first envelope, wherein when the first outlet of the first pump is operational the first pump is operable to move gas from the inter-envelope region to inside the inner surface of the first envelope;
a second outlet situated outside of an outer surface of the second envelope, wherein when the second outlet is operational the first pump is operable to move gas from the inter-envelope region to outside the outer surface of the second envelope; and
an outlet valve switchable between at least the first outlet and the second outlet and communicatively coupled to the logic controller.

9. The high-altitude balloon apparatus of claim 1, further comprising:
a logger communicatively coupled to the logic controller and operable to receive, store and communicate historical data from one or more sensors; and
a communication unit communicatively coupled to the logic controller and operable to transmit data onto a communication network, wherein the logic controller analyzes the historical data from the logger and effectuates transmission of data through the communication unit based on a deviation from the historical data.

10. A system comprising:
an inner container;
an outer container encompassing the inner container and forming a region between the inner container and the outer container; and
a pump with an inlet situated in the region between the inner container and outer container.

11. The system of claim 10, further comprising a logic controller communicatively coupled to the pump and configured to activate the pump in moving fluid out of the region between the inner container and the outer container according to a defined logic.

12. The system of claim 11, further comprising a pressure sensor in the region between the inner container and the outer container, the pressure sensor being communicatively coupled to the logic controller.

13. The system of claim 12, further comprising a power controller communicatively coupled to the logic controller.

14. A method comprising:
measuring leakage into an inter-vessel region formed between a first vessel and a second vessel that encompasses the first vessel;
determining whether the leakage exceeds a first threshold; and
activating a pump based on the determination of whether the leakage exceeds the first threshold.

15. The method of claim 14, wherein measuring leakage includes measuring gaseous pressure in the inter-vessel region, and the first threshold is a measured pressure in the inter-vessel region.

16. The method of claim 15, further comprising:
measuring pressure in the inter-vessel region periodically;
determining whether the pressure is below a second threshold; and
deactivating the pump based on the determination of whether the pressure is below the second threshold.

17. The method of claim 14, wherein measuring leakage includes measuring a level of a predefined substance in the inter-vessel region.

18. The method of claim 14, wherein activating the pump moves a fluid from the inter-vessel region into the first vessel.

19. The method of claim 14, wherein activating the pump moves a fluid from the inter-vessel region to outside the second vessel.

20. The method of claim 14, further comprising:
determining whether a majority of the leakage into the inter-vessel region is from fluids escaping the first vessel or from fluids passing into the inter-vessel region from outside the second vessel; and
configuring the pump based on the determination of the majority of the leakage.
